(19) United States
(12) Patent Application Publication
(10) Pub. No.: US 2005/0259572 A1
(43) Pub. Date: Nov. 24, 2005

(54) Distributed high availability system and method

(76) Inventors: Kouros H. Esfahany, Huntington, NY (US); Michael R. Chiaramonte, Centereach, NY (US)

Correspondence Address: BAKER BOTTS L.L.P., 2001 ROSS AVENUE, SUITE 600, DALLAS, TX, 75201-2980, US

(21) Appl. No.: 11/132,745

(22) Filed: May 18, 2005

Related U.S. Application Data
(60) Provisional application No. 60/572,518, filed on May 19, 2004.

(51) Int. Cl. H04L 12/26

(52) U.S. Cl. 370/217

(57) ABSTRACT

A network of computer resources includes a plurality of heterogeneous nodes. Each node meets predetermined minimum standards. The nodes are interconnected, either directly or indirectly, to one another over a high-speed data network. A distributed service layer circulates status data pertaining to the plurality of heterogeneous nodes throughout the interconnection of nodes.

### REFERENCE TO RELATED APPLICATION

The present application is based on and claims the benefit of provisional application Ser. No. 60/572,518, filed May 19, 2004, the entire contents of which are herein incorporated by reference.

### BACKGROUND

1. Technical Field

Tis application relates generally to computer system management, and more particularly to a distributed high availability system and method.

2. Description of the Related Art

A cluster is a group of servers and other resources that act like a single system. Clusters currently function to provide high availability to applications and services. When applications or services are defined as part of a cluster, they become highly available because the cluster software continuously monitors their status and lets the applications failover between nodes if there are problems. High availability minimizes down time for applications such as databases and web servers. Briefly, nodes refer to addressable devices attached to a computer network, typically computer platforms or hardware running operating systems and various application services. A clustering service may define the association of nodes with the cluster.

Clusters typically require that all systems within the cluster be within a tightly confined area, often within the same room so that all systems may utilize relatively low-speed communication and data transfer hardware. Clusters can thus become susceptible to single point failures such as power or network failures within a facility, building, or the general area in which the systems in the cluster are located. Although the cluster may be aware of what has happened, it cannot react or reduce downtime because the cause of the failure is in the sustaining systems, not in the hardware or software involved in the clusters. A sustaining system, for example, is an infrastructure or any entity, which may be required in order to ensure that the hardware and software that provide a given service can function properly. Examples of a sustaining system may include, but are not limited to, national electrical power grids, high-speed network infrastructures, and communications infrastructures, etc.

Further, while clusters may provide better service than traditional servers and may be capable of handling bottlenecks when there is a requirement to be able to distribute or transport large amounts of data to and from client users, even in clustered systems, data may still need to be transported over long distances.

### SUMMARY

A network of computer resources includes a plurality of heterogeneous nodes. Each node meets predetermined minimum standards. The nodes are interconnected, either directly or indirectly, to one another over a high-speed data network. A distributed service layer circulates status data pertaining to the plurality of heterogeneous nodes throughout the interconnection of nodes.

A method for utilizing a network of computer resources. A plurality of heterogeneous nodes is interconnected. Each node meeting predetermined minimum standards. The nodes are interconnected either directly or indirectly, to one another over a high-speed data network. Status data pertaining to the plurality of heterogeneous nodes is circulated throughout the interconnection of nodes.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a diagram illustrating the architecture of the SPAN DHAS according to an embodiment of the present disclosure;

FIG. 2 is an architectural diagram illustrating the components of DHAS according to an embodiment of the present disclosure;

FIG. 3 is a flow diagram illustrating a method of determining and adding nodes in the SPAN for circulating a heartbeat among the nodes in the SPAN according to an embodiment of the present disclosure;

FIG. 4 illustrates a method used according to an embodiment of the present disclosure to ensure that the heartbeat reaches its destination;

FIG. 5 is another architectural diagram illustrating the components of the DHAS according to an embodiment of the present disclosure;

FIG. 6 illustrates a two-process method according to an embodiment of the present disclosure; and

FIG. 7 shows an example of a computer system capable of implementing the method and apparatus according to embodiments of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

A distributed high availability system (DHAS) according to an embodiment of the present disclosure distributes a plurality of elements of a scattered persistent availability network (SPAN) to various geographic areas. Accordingly, DHAS may avoid or reduce system failures occurring as a result of geographically centered outages.

DHAS, according to one embodiment of the present disclosure, provide cluster-like functionality and high availability across heterogeneous nodes from multiple vendors with the added ability of geographically dispersed locations. This approach allows business critical applications to remain highly available without dependency to a specific vendor cluster solution. DHAS works to minimize downtime and makes optimal use of an underlying network to ensure that the target application is continuously functional and available. DHAS enables applications to become fault tolerant and thus highly available, for example, without the necessity of being in a cluster environment. Applications further benefit from the ability to be geographically separated because the whole of the SPAN may be shielded from local failures such as network outages and/or power outages.

DHAS, according to an embodiment of the present disclosure, also provides a grid-like computing environment by distributing the application to load across the target network. In addition to the speed gained due to parallel processing, SPANs enhance the ability to distribute information more quickly due to the possibility of having nodes in the SPAN closer to a user than a traditional server or cluster.

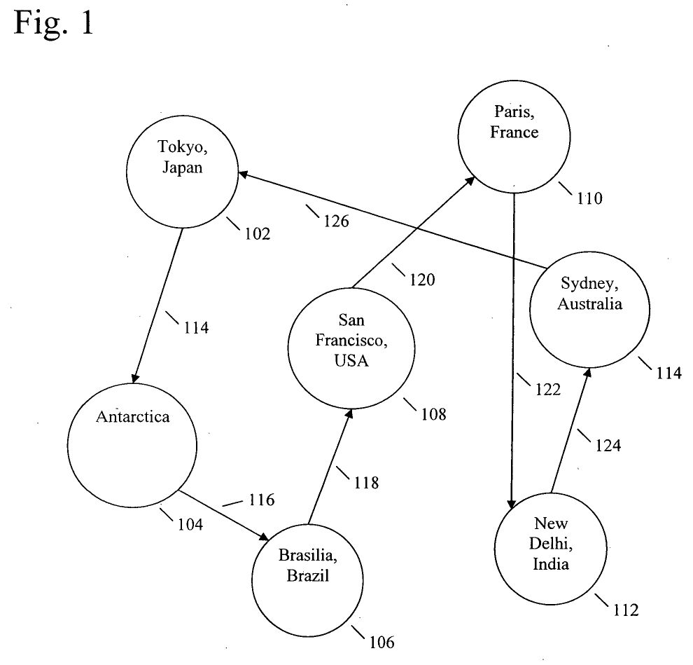

FIG. 1 is a diagram illustrating the architecture of the SPAN DHAS according to an embodiment of the present disclosure. High availability describes software that is monitored and managed by a cluster. When an application is defined as part of a cluster, it may become highly available because the cluster software continuously monitors its status and lets the application failover between nodes. For example, the SPAN may allow a clone application on another node in the cluster to take over should there be a problem with the node executing the application. SPAN may be a plurality of heterogeneous systems 102-112 which may be loosely bound across networks and even geographical regions to provide a service worldwide. Every SPAN node 102-112 may be defined to have a minimum set of functional hardware and software in order to provide the service. By having this minimum set in each node, a service running on one node in the SPAN may be capable of running on any node within the SPAN. For example, a service such as a web server may make use of at least a 1.2 GHz (gigahertz) capacity processor and 2 GB (gigabytes) of RAM (random access memory). Since this is a requirement for this particular service, some if not all systems of the SPAN, should meet at least this requirement in order to ensure that the web server can fail-over from one node to at least one other node within the SPAN. If a failure occurs on any node, the services that had been running on that node may migrate across the SPAN to any other available node. However, there is no requirement that all the nodes or the systems in the nodes be identical.

No specific hardware requirements may be necessary for DHAS. Rather, these requirements may be dictated by the service being provided. For example, if a given service requires large amounts of memory, hardware with large memory capacity may be used. DHAS, according to an embodiment of the present disclosure, may act as a thin service providing fault-tolerance and high availability to any enterprise.

According to an embodiment of the present disclosure, all nodes within the DHAS are able to communicate with all other nodes, either directly or indirectly. For example, there may be multiple paths of communication between nodes. Each of the multiple paths may be linked to a different node in the SPAN. In another example, a node may be linked to another node in the SPAN indirectly by a link to an intermediary node in the SPAN. A consistent SPAN may therefore be maintained and any single node may be prevented from becoming a point of failure. All nodes may use a high-speed communications network and all nodes may be able to access the same shared storage, whether a large distributed Storage Area Network (SAN) or a newly developed technology. The nodes in the SPAN running DHAS may be heterogeneous, for example, able to run under different platforms.

Having high-speed inter-node communication may provide fast responses to failures and bottlenecks. A fast method of communication may ensure, for example, that within seconds of a SPAN-wide event another node becomes aware of the event and responds appropriately. An example of a high-speed communications system includes, but is not limited to, 100 MBps Ethernet.

DHAS, according to an embodiment of the present disclosure, may include high-speed shared and/or distributed storage as a way to access data needed for a service running under the DHAS as part of the service's functionality. Examples of high-speed shared and/or distributed storage include, but are not limited to, high-speed storage networked to a large-area SAN. The system for accessing the high-speed network storage, for example, may be provided by an operating system that the nodes are running.

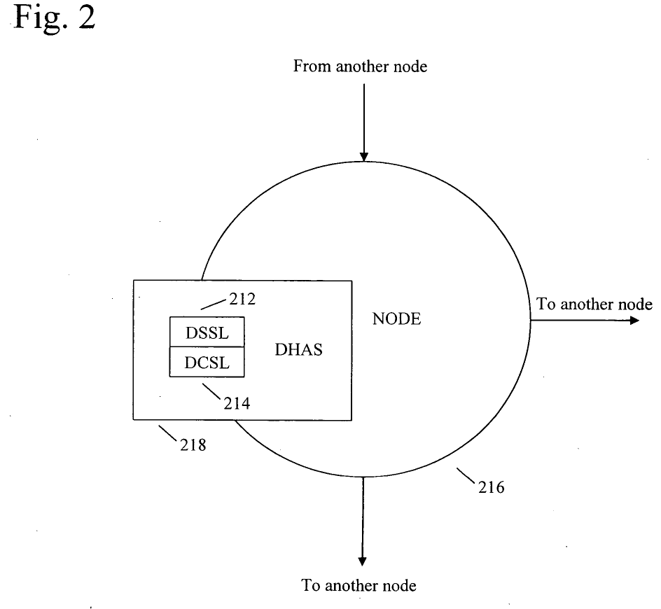

FIG. 2 is an architectural diagram illustrating the components of DHAS according to an embodiment of the present disclosure. DHAS 218 may include a distributed SPAN service layer (DSSL) 212 and a distributed client service layer (DCSL) 214 for providing high-performance SPAN functionality. DHAS 218, as shown, may reside in each node 216 in the SPAN. The distributed span service layer (DSSL) 212, according to an embodiment of the present disclosure, is responsible for maintaining information about the entire SPAN within every node of the SPAN. This may be accomplished using various mechanisms.

For example, according to an embodiment of the present disclosure, node information may be maintained using a SPAN-wide heartbeat. The heartbeat may be a set of data that is circulated among all the nodes in the SPAN. FIG. 1, for example, shows how the data may circulate. The nodes 102-112 may be organized by a node identifier (ID). According to an embodiment, the nodes 102-112 may be organized based on geographical region in the order that minimizes the distance data travels between the nodes in the SPAN. In addition, the service layer (DSSL FIG. 2 212) may determine the round-trip time during configuration and configure the order based on the shortest data transfer times. According to an embodiment, this configuration may change after the initial configuration in order to provide optimal round-trip times.

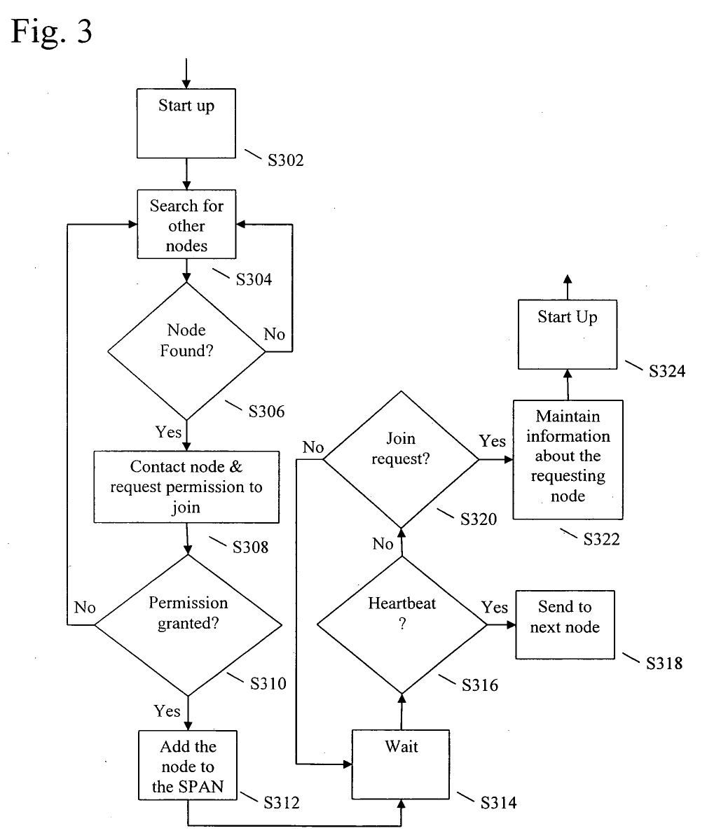

Once the nodes are identified, a cycle among the nodes may be established, for example, as a path from one node to another in the SPAN 114-126 (FIG. 1). The heartbeat may be transmitted by each node to the next according to this cycle. FIG. 3 is a flow diagram illustrating a method of determining and adding nodes in the SPAN for circulating a heartbeat among the nodes in the SPAN according to an embodiment of the present disclosure. Upon startup (Step S302), the service layer (212 FIG. 2) searches for other nodes within the SPAN (Step S304). The search may be done, for example, by attempting to connect via an established communications method to any node within the SPAN. If no node is found (No, Step S306), then other nodes may be searched for (Step S304). The node that was started may wait until another node can be found (Yes, Step S306) before continuing. If any node within the SPAN is currently running the distributed SPAN service and has joined the SPAN (Yes, Step S306), then the service (that performed the search) may contact that node (the node found to be running the distributed SPAN service that is already a member of the SPAN), requesting permission to join (Step S308). If no permission is granted (No, Step S310), then other nodes may be searched for (Step S304). If permission is granted (Yes, Step S310), the new node (the node that performed the search) may be added to the SPAN (Step S312). For example, the node that is contacted and granted the permission may inform other nodes in the SPAN about the new node (for example, the IP address of the new node) so that the heartbeat may be sent to this new node from other nodes.

The node may then wait for incoming connections (Step S314). The node can receive a heartbeat. The new node may be contacted by the heartbeat as the heartbeat runs through the cycle of the nodes in the SPAN. When the heartbeat, during its circulation through the nodes, reaches this new node, the heartbeat may be updated with the information about the node. For instance, the DSSL on that node may update the heartbeat with the needed information. This information may include, but is not limited to, the number of nodes, the IP address of the nodes, and the statuses of the nodes within the SPAN.

For example, a join request may be received from another node that subsequently gets started. In one embodiment, a join request may be made from and to any node within the SPAN. If there are no nodes running the service, a node that is started initially may make up the SPAN. When another node joins the SPAN, a heartbeat may be circulated and updated.

A node can receive either a heartbeat or a join request. If a heartbeat is received (Yes, Step S316) the information about the nodes that are making the contact is received from the previous node that sent the heartbeat, and is updated with current node information. Current node information may include, for example, the nodes currently known to the contacted node and/or information about nodes that have joined. The heartbeat may then be sent to the next node (Step S318). If no heartbeat is received (No, Step S316), it may be determined whether a join request has been received (Step S320). If a join request is received (Yes, Step S320) the request may be granted and a new node added to the SPAN, for example, by collecting information about the new node (Step S322) and informing other nodes in the SPAN about the new node (Step S324). If no heartbeat has been received (No, Step S316) and no join request has been received (No, Step S320) then the node may continue to wait for incoming connections (Step S314).

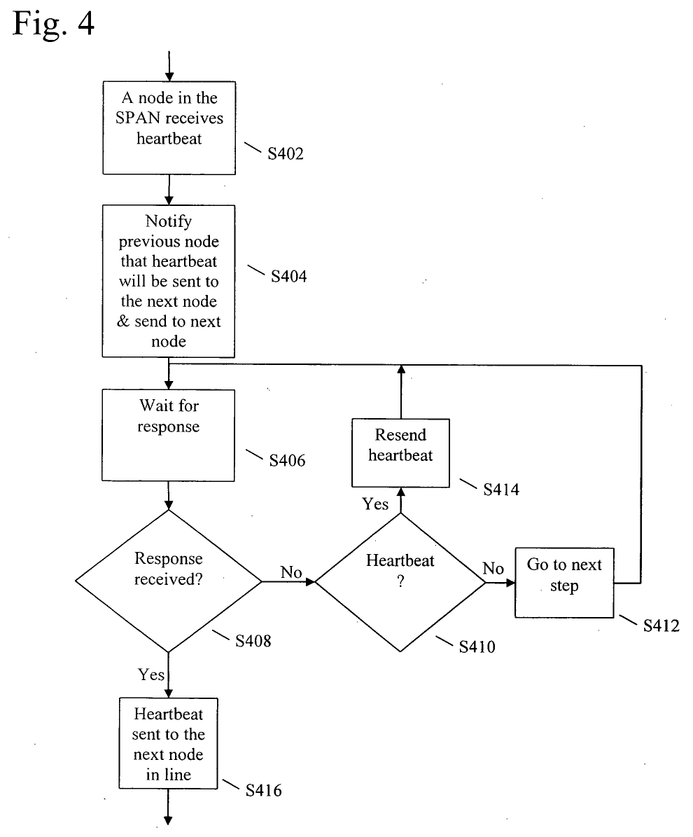

FIG. 4 illustrates a method according to an embodiment of the present disclosure for ensuring that the heartbeat reaches its destination. The heartbeat information may be transmitted, for example, using TCP/IP. A node in the SPAN may receive a heartbeat (Step S402). This node (for example, FIG. 1, 104) may tell the node (FIG. 1, 102) from which it received the heartbeat, that it (FIG. 1, 104) is sending the heartbeat to the next node (FIG. 1, 106) (Step S404). The sending node (FIG. 1, 104) may wait for the receiving node (FIG. 1, 106) to tell it (FIG. 1, 104) that the receiving node (FIG. 1, 106) is successfully transmitting its data to the next node (FIG. 1, 108) (Step S406). If the acknowledgment is not received within a predetermined timeout period (No, Step S408), for example, 30 seconds, from the receiving node (FIG. 1, 106) then it (FIG. 1, 104) may try to establish a connection to that node (FIG. 1, 106) again.

In trying to establish a connection to that node again, if a connection to the receiving node (FIG. 1, 106) can be established (Yes, Step S410), a heartbeat may be sent again (Step S414) and then goes back to waiting (Step S406). This retry may be performed, for a predetermined number of times, and if no response is received, a next node may be tried. If a connection to the receiving node (FIG. ,1 106) cannot be established (No, Step S410) then it is considered to be “down” (unavailable) and the next node (FIG. 1, 108) may be tried (Step S412). If the receiving node (FIG. 1, 106) responds (Yes, Step S408) the heartbeat may be sent again to the next node (Step S416). This may follow the same method but with the receiving node (FIG. 1, 106) being the sending node and the next node (FIG. 1, 108) being the receiving node. According to an embodiment of the present disclosure, if a receiving node receives the same packet twice, for example, due to slow network transmissions of the acknowledgment, the second packet may be discarded.

The above-described method may ensure that a single heartbeat is circulated throughout the SPAN without failure. Each node that is transmitting may be responsible to its previous node, thereby forming a circular dependency. There may be provisions to ensure that deadlocks do not occur. For example, a predetermined amount of time to wait for a response may be set and if the response is not received, move to the next node.

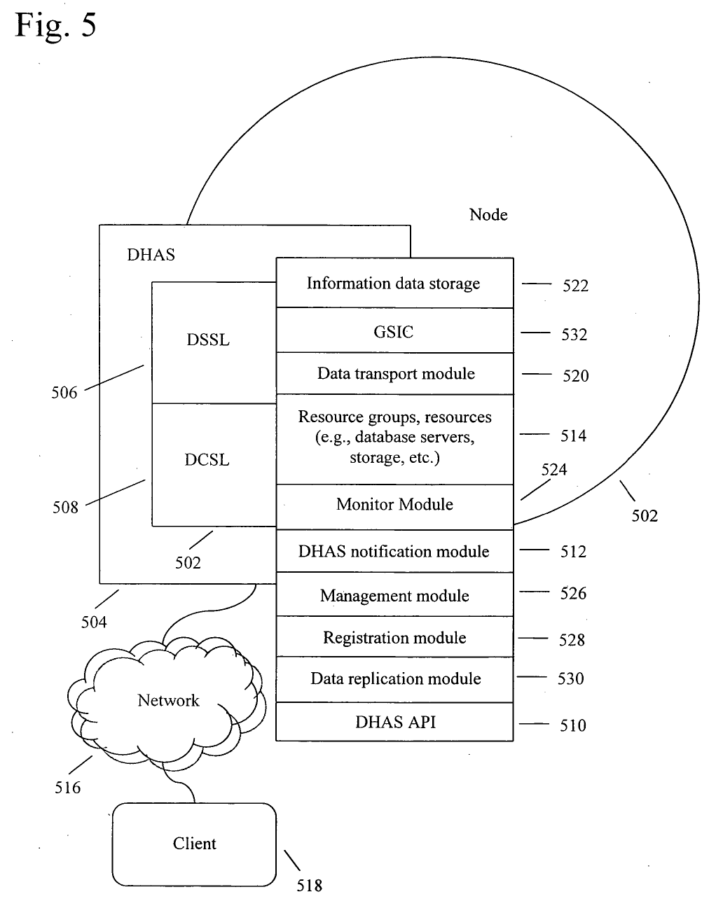

DCSL component (214 FIG. 2) of the DHAS may be a component that interfaces with the client side. FIG. 5 is a diagram illustrating the components of the DHAS according to an embodiment of the present disclosure. DCSL 508 may gather information about the highly available applications and services being monitored by DHAS running on the SPAN and provide the information to the client side, for example, through an API as a well-defined way of exchanging data. As part of DCSL 508, DHAS may provide an extensive C language implemented application programming interface (API), DHAS API 510, for all platforms on which it operates. The API 510, according to an embodiment of the present disclosure, may allow clients 518 of the services on the SPAN node 502 to obtain information available about the SPAN, and also to communicate with the services 514 running on the SPAN nodes. For example, clients 518 connect to the SPAN for information through the DCSL 508, which provides the API 510 for exchanging data between clients and the SPAN. In one aspect, allowing the client 518 to communicate with the services 516 rather than to the nodes 502 directly allows highly available services to migrate between nodes without the client being required to know which node in the SPAN the service is currently running on.

DHAS notification service module 512 may allow clients to request real-time notification of events within the SPAN. These events can include a notice when a node has joined the SPAN and a notice of changed status of a node within a SPAN. These events or notifications may be retrieved directly from the DHAS notification module 512, for example, via the API 510, or via a forwarded event notification system, a part of data transport module 520, that operates in a manner similar to the heartbeat.

According to an embodiment of the present disclosure, every node may maintain a set of resource groups 514 that are active within the SPAN. A resource group is a logical entity defined for a particular application or service, which contains within it the resources needed in order to provide that service to clients 518. An example of such a service is a database for a product order system. The database server and the resources the database server needs for its operations may be within the resource group 514. An example of a resource may be a shared disk or IP address. When a resource group 514 is started, the resource group may start all of its required resources and the associated service through user-defined means, for example, as defined in the resource group. Then the resource group may notify the rest of the nodes in the SPAN that it has been started. If the resource group fails, for example, because the node loses power unexpectedly, another node in the SPAN may restart the resource group locally to ensure that the service is still provided.

According to an embodiment of the present disclosure, there are two types of resource groups. A single-instance-single-location (SISL) resource group may run a single service on one node in the SPAN at a time. If the single service fails, it may be restarted on another node in the SPAN either based on the SPAN service's determination of what and where it should be started or based on rules that the user has defined.

A single-instance-multi-location (SIML) resource group may run a single service on every node in the SPAN in parallel. This allows for faster performance that may be required such as in a web server, and if any of the nodes should fail the other nodes will seamlessly continue to work as before.

In addition, because the SPAN has all the nodes interconnected with a very high-speed network, it is capable of resolving data flow path problems. For example, if it is determined that a resource or particular system is unreachable from one node in the SPAN, but not from another, then the data is routed through the node capable of accessing the data as a proxy. While this is happening, an alert may be raised to alert the administrator of the SPAN that there is an error which has been resolved but may need intervention.

According to an embodiment of the present disclosure, if a node failure occurs, it is detected upon failure of heartbeat transmission, and the node sending the heartbeat may modify the information transmitted by the heartbeat to allow the other nodes in the SPAN to become aware of this failure. Further, the monitoring module 524 on the transmitting node may determine what services have failed as a result of the node's failure, and causes a fail-over to begin. If the fail-over starts the service on the transmitting nodes, all remaining nodes may be notified through the data-transport module 520, for example, by contacting the management module 526. The management module 526 may set correct statuses internally and use the notification module 512 to notify any client applications within the SPAN connected to that particular SPAN node that a change has occurred, if appropriate.

According to an embodiment of the present disclosure, high availability service (HAS) disclosed in U.S. patent application Ser. No. 10/418,459, entitled METHOD AND SYSTEM FOR MAKING AN APPLICATION HIGHLY AVAILABLE, assigned to the same assignee, may be used as the API 510 for retrieving information and notifications of events within the SPAN. This may allow any component (such as agent technology) integrated with HAS to detect and operate properly within the SPAN environment. U.S. patent application Ser. No. 10/418,459 is incorporated herein by reference in its entirety.

A common communication standard such as the DIA (distributed information architecture) may be used to transport data in the SPAN, for example, by a data transport module 520. DIA includes an ability not only to transfer data quickly, but also the ability to work through firewalls and other obstructions that would normally hinder an application or service from communicating.

DHAS according to an embodiment of the present disclosure may include three models of data access. A share-all model allows every node in the SPAN to access the required shared data simultaneously through high-speed shared storage such as a SAN. In a share-nothing model, data is not shared via high-speed shared storage. Rather it may be replicated through DIA or some other high-speed transport. A hybrid model may include a combination of the share-all model and the share-nothing model as necessary.

According to an embodiment of the present disclosure, the DHAS may include parent and child processes. The parent process is responsible for ensuring that the DHAS child processing is running. If the child is not running, the parent process may restart it. Likewise, the child process may restart the parent process if it determines that the parent process is not running. This two-process mechanism ensures that DHAS will always be running.

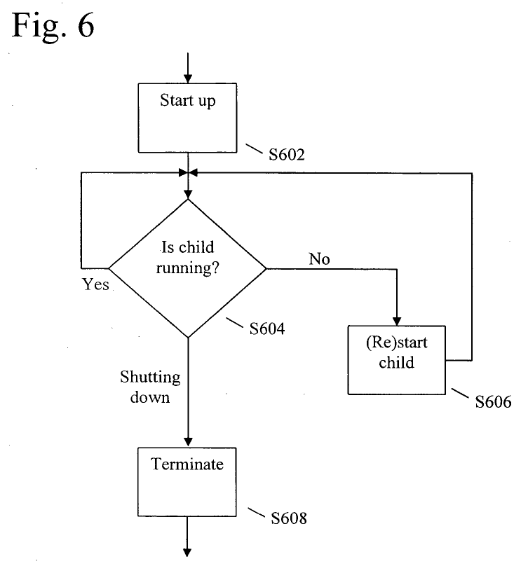

FIG. 6 illustrates this two-process method according to one embodiment of the present disclosure. The DHAS may be started (Step S602). A parent process may continuously monitor a running child process (Step S604). The child process, for example, may be responsible for running the DHAS functionalities. If the child process is not running (No, Step S604) then the child process may be started or restarted (Step S606). When the child process is restarted (Step S606), it is determined whether the last running state was properly terminated, and if it was not, shared memory structures, inter-process structures, and other data may be cleaned up in order to ensure the proper restart of the DHAS facilities. If the child process is running (Yes, Step S604) then the monitoring may be continued (Step S604). The DHAS may be terminated, for example, during a shut down stage of the nodes and the systems (Step S608). When the child process detects that the parent process is not running, the child process may restart the parent process to continue monitoring the child process.

As described above, DHAS may maintain the status of its nodes within the SPAN with a heartbeat that circulates throughout the entire SPAN. According to an embodiment of the present disclosure, to ensure that the heartbeat is small, the heartbeat may contain only information about the current status of the nodes within the SPAN. All nodes within the SPAN may maintain information about all the other nodes locally.

Referring back to FIG. 5, resource group information may be stored locally as shown at 522 as well as on the shared storage to which all SPAN nodes have access. Resource group information, for example, may include the current location and status of the resource group, what service is related to the resource group, and/or what resources are associated with the resource group (Internet Protocol addresses, storage, etc.). For example, in the case of SPAN-wide component changes, resource group failovers, etc., the component database, a small data-store which maintains the current status of all resource groups on the shared storage, may be updated and a generic notification may be sent by the detecting node to all nodes in the SPAN. This ensures that notifications are quick and small. Each SPAN node may determine the cause of the notification. In the case of a configuration with no shared storage, the generic notification may be supplemented by additional information regarding the change that occurred.

If software is required to be installed across the entire SPAN, it may not be necessary to install the software on every node. Software which is DHAS enabled may be installed on a single node and the installation may be made available to all the other nodes via the shared storage. For example, a software delivery option (IDM/SDO) may install the component in each node without any further interaction from the user.

According to an embodiment of the present disclosure, the DHAS API may allow a client application in each node to create resource groups and resources. A resource group may be a logical coupling of resources that are needed to run a particular application or service. A resource may be anything that is required by the service or application to run properly, for example, IP address or shared storage. The DHAS API may also allow a client to receive notifications based on resource changes via the DCSL API and get information about resources, resource groups, and the SPAN.

According to an embodiment of the present disclosure, the SPAN services may include one or more modules that perform the operations of the SPAN. For example, one module 524 may be responsible for monitoring resources defined to the SPAN and running on the current node. Another module 512 may be responsible for sending out notifications when resources, resource group, and/or any other components change states. Yet another module 526 may be responsible for remediation of failed resources, for example, such as restarting or possibly performing functions necessary for failover in a multi-node SPAN. Still yet another module 528 may be responsible for taking care of resource registration and other overhead relating to defining a resource or group across a SPAN. For example, registration module 528 may facilitate the automatic creation of the proper content to be replicated by the data replication module 530. Another module 530 may be responsible for replicating data across SPAN nodes. The replicated data may include, for example, internal databases and/or applications and component data.

The above-described functionalities, of course are not limited to each module described above. Thus, one module may perform all the functions described above or different modules can perform different functions.

Generic SPAN information collector (GSIC) 532 may be responsible for gathering and distributing all the information about the SPAN, for example node status, resource and/or resource group status across the SPAN. The GSIC 532 may include a heartbeat to all nodes in the SPAN to make sure all nodes are running.

The DHAS, according to an embodiment of the present disclosure, may be enabled to handle load balancing. Load balancing is the ability to take multiple identical services within a SPAN and have them running across multiple nodes within that SPAN simultaneously. User requests may be dynamically routed through a lead node or lead server to nodes that are less utilized within the entire group that is load balancing. This may be accomplished, for example, by having a lead server for rerouting the requests to request status from the processing servers. When the values are returned, the lead server may determine which processing server is least used and give the request to that server. This, for example, may be performed for all server data requests so that minimum response time is achieved by ensuring that servers are never critically over utilized.

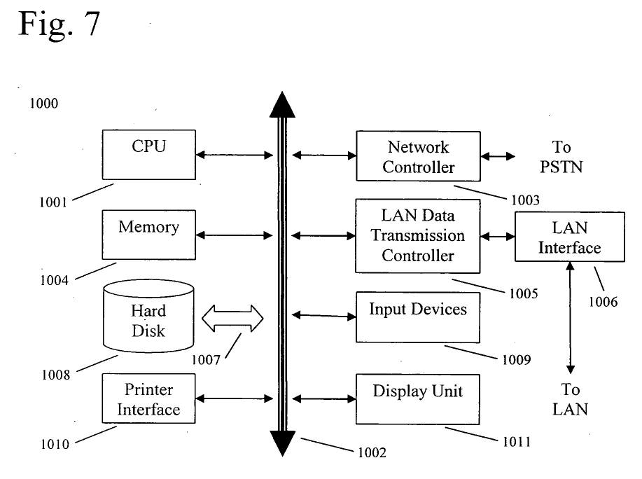

FIG. 7 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

1. A network of computer resources, comprising:
a plurality of heterogeneous nodes, each meeting predetermined minimum standards, interconnected, either directly or indirectly, to one another over a high-speed data network; and
a distributed service layer for circulating status data pertaining to the plurality of heterogeneous nodes throughout the interconnection of nodes.

2. The system of claim 1, additionally comprising a distributed service layer for providing parallel processing of one or more applications throughout said system of interconnected nodes.

3. The system of claim 1, additionally comprising a distributed service layer for providing fail-over such that execution of an application on one node may be seamlessly transferred to another node in the event that said one node fails.

4. The system of claim 1, additionally comprising a distributed service layer for providing load balancing such that execution of an application may occur on one or more of said plurality of heterogeneous nodes based on node availability.

5. The system of claim 1, additionally comprising a shared storage system for sharing data amongst said plurality of heterogeneous nodes.

6. The system of claim 5 wherein said shared storage system is a distributed storage area network (SAN).

7. The system of claim 1, wherein data is replicated over said plurality of heterogeneous nodes.

8. The system of claim 1 wherein one or more of said plurality of heterogeneous nodes are geographically diverse.

9. The system of claim 8, wherein execution of an application may occur on one or more of said plurality of heterogeneous nodes based on proximity.

10. The system of claim 1, wherein data-flow path interruptions are automatically resolved by rerouting data over said high-speed data network

11. The system of claim 1, additionally comprising a thin-server executing on a distributed service layer for providing fault tolerance and high availability.

12. The system of claim 1, additionally comprising an application program interface (API) for providing in

13. The system of claim 1, additionally comprising a distributed service layer for providing execution of an application throughout said system of interconnected nodes, wherein a parent-process is executed on said service layer for providing execution and said parent-process restarts said application when said application stops executing.

14. The system of claim 13 wherein said application restarts said parent-process when said parent process stops executing.

15. The system of claim 1, wherein an application installed on one of said plurality of heterogeneous nodes may be made available to each of said plurality of heterogeneous nodes.

16. A method for utilizing a network of computer resources, comprising:
interconnecting a plurality of heterogeneous nodes, each meeting predetermined minimum standards, either directly or indirectly, to one another over a high-speed data network; and
circulating status data pertaining to the plurality of heterogeneous nodes throughout the interconnection of nodes.

17. The method of claim 16, additionally comprising the step of providing parallel processing of one or more applications throughout said system of interconnected nodes.

18. The method of claim 16, additionally comprising the step of providing fail-over such that execution of an application on one node may be seamlessly transferred to another node in the event that said one node fails.

19. The method of claim 16, additionally comprising the step of providing load balancing such that execution of an application may occur on one or more of said plurality of heterogeneous nodes based on node availability.

20. The method of claim 16, additionally comprising the step of sharing data amongst said plurality of heterogeneous nodes.

21. The method of claim 20 wherein said step of sharing is performed by a distributed storage area network (SAN).

22. The method of claim 16, wherein data is replicated over said plurality of heterogeneous nodes.

23. The method of claim 16 wherein one or more of said plurality of heterogeneous nodes are geographically diverse.

24. The method of claim 23, wherein execution of an application may occur on one or more of said plurality of heterogeneous nodes based on proximity.

25. The method of claim 16, wherein data-flow path interruptions are automatically resolved by rerouting data over said high-speed data network

26. The method of claim 16, additionally comprising the step of executing a thin-server on a distributed service layer for providing fault tolerance and high availability.

27. The method of claim 16, additionally comprising the step of providing an application program interface (API) for providing in

28. The method of claim 16, additionally comprising the step of providing execution of an application throughout said system of interconnected nodes, wherein a parent-process is executed on said service layer for providing execution and said parent-process restarts said application when said application stops executing.

29. The method of claim 28 wherein said application restarts said parent-process when said parent process stops executing.

30. The method of claim 16, wherein an application installed on one of said plurality of heterogeneous nodes may be made available to each of said plurality of heterogeneous nodes.
